(19) United States
(12) Patent Application Publication
(10) Pub. No.: US 2007/0156836 A1
(43) Pub. Date: Jul. 5, 2007

(54) System and method for electronic chat identity validation

(75) Inventors: Scott Edwards Kelso, Durham, NC (US); John C. Mese, Cary, NC (US); Nathan J. Peterson, Raleigh, NC (US); Rod David Waltermann, Durham, NC (US); Arnold S. Weksler, Raleigh, NC (US)

Correspondence Address: LENOVO - JVL;C/O VANLEEUWEN & VANLEEUWEN, P.O. BOX 90609, AUSTIN, TX, 78709-0609, US

(73) Assignee: Lenovo(Singapore) Pte. Ltd.

(21) Appl. No.: 11/326,010

(22) Filed: Jan. 5, 2006

(51) Int. Cl. G06F 15/16

(52) U.S. Cl. 709/207

(57) ABSTRACT

A system and method that validates the identity of an instant messaging session user is provided. An instant messaging session is established between two instant messaging applications running on two different computers connected through a computer network. After the instant messaging session has been established, one of the users requests identity authentication of the other user. The other user supplies the requested identity authentication data, such as a password. The identity authentication data is verified and, if the identity authentication data is successfully verified, a secure message is displayed.

### BACKGROUND OF THE INVENTION

1. Technical Field

The present invention relates in general to a system and method for validating identities. More particularly, the present invention relates to a system and method for validating the identities of electronic chat participants.

2. Description of the Related Art

Email is replacing the telephone as a preferred method of communication between individuals. However, email may not be a responsive form of communication for particular situations. For example, a user may require an immediate answer to a question, such as “The meeting has started, are you attending?” In this example, an email recipient may be working on a document and may not have his email account active.

Instant messaging has gained popularity, in part, because a user has an indication of whether a recipient will receive an instant message in a timely manner. The user accomplishes this by checking whether the recipient is logged into an instant messaging server. The instant messaging server handles instant messages that a source sends to a target and informs a source as to which targets included in a source's buddy list are logged on to the instant messaging server.

A challenge with instant messaging is that the parties to an instant messaging session are not sure of the identity of the other party. This can result in sensitive or confidential information being viewed by an unintended recipient. For example, a user may establish an instant messaging with someone in the personnel department in order to gather some basic information. Much of the information may not be considered sensitive, such as the user's name. However, other information, such as the user's social security number or salary information, may be considered highly sensitive. If the user uses instant messaging to send sensitive information using traditional instant messaging applications, the sensitive information is displayed alongside the other information. If the personnel department employee left his or her workstation unattended or if another person entered the personnel employee's office to discuss something, the sensitive information would be visible on the personnel employee's computer display.

What is needed, therefore, is a system and method that provides for validating and authenticating messages sent using instant messaging systems. What is further needed, is a system and method that protects sensitive information transmitted during an instant messaging session until the recipient's identity is verified.

### SUMMARY

It has been discovered that the aforementioned challenges are resolved using a system and method that validates the identity of an instant messaging session user. An instant messaging session is established between two instant messaging applications running on two different computers connected through a computer network. After the instant messaging session has been established, one of the users requests identity authentication of the other user. The other user supplies the requested identity authentication data, such as a password. The identity authentication data is verified and, if the identity authentication data is successfully verified, a secure message is displayed.

In one embodiment, the secure message is sent from one of the computers to the other computer and, instead of displaying the secure text, a control, such as a command button is displayed in the user's instant messaging application. When the user selects the control, such as by clicking on the command button, the user is prompted for the identity authentication data. If the data is verified, the secure message is displayed. In one embodiment, the secure message is displayed in a pop-up window so that, when the pop-up window is closed, the only way to re-display the secure message is by clicking on the control and providing the authentication data. In one embodiment, the secure message is stored in an encrypted fashion until the identity authentication data is provided.

In one embodiment, a message server is used to facilitate authentication instant messaging session users. In this embodiment, the authentication request is sent to the instant messaging server. The server then requests authentication data from one of the users. This data is returned and evaluated by the message server. If the identity of the user is verified by the message server, the message server sends an appropriate message to the other user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing an electronic message session between two computers;

FIG. 2 is a diagram showing one of the computers sending a secure message to the other computer;

FIG. 3 is a diagram showing the secure message being received and authenticated by one of the computers;

FIG. 4 is a flowchart showing steps taken in sending and receiving secure instant messages between two computers;

FIG. 5 is a flowchart showing steps taken in displaying a secure instant message;

FIG. 6 is a diagram showing a message server being used to facilitate the transmission and reception of secure messages;

FIG. 7 is a diagram showing the message server authenticating a user before transmitting a secure message;

FIG. 8 is a flowchart showing steps taken in sending and receiving secure instant messages between two computers using a message server to facilitate authentication; and

FIG. 9 is a block diagram of an information processing system capable of performing the computations contemplated in the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

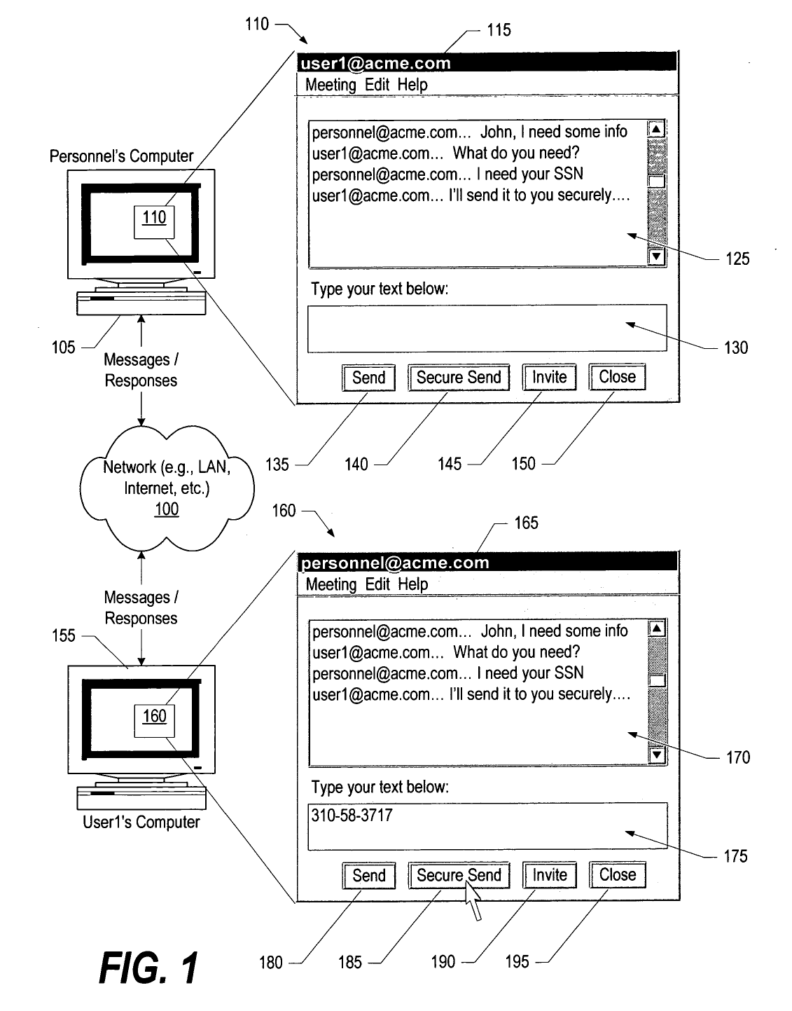

FIG. 1 is a diagram showing an electronic message session between two computers. In the example, an instant messaging session has been established between an employee in the personnel department (personnel computer 105 running an instant messaging application in window 110) and an employee (user1 computer 155 running an instant messaging application in window 160). The computers are connected to one another through computer networks 100, such as a local area network (LAN), the Internet, etc.

The instant messaging applications include title bars that identify the other user in the instant messaging session. Personnel's instant messaging session 110 has title bar 115 that indicates that the personnel's computer is communicating with “user1@acme.com”. Likewise, the employee's instant messaging session 160 has title bar 165 that indicates that the employee's computer is communicating with “personnel@acme.com”.

Each of the instant messaging sessions includes a display window where messages sent and received during the session are displayed (personnel's instant messaging session has display window 125 and the employee's instant messaging session has display window 170). In addition, each of the instant messaging sessions includes an input window where messages to be sent to the other user are entered (personnel's instant messaging session has input window 130 and the employee's instant messaging session has input window 175).

Each instant messaging application has command buttons to perform various functions. Send command buttons 135 and 180 are used to send text entered in text boxes 130 and 175, respectively, to the other user in a non-secure fashion. Secure Send command buttons 140 and 185 are used to send text entered in text boxes 130 and 175, respectively, to the other user in a secure fashion.

In addition, each instant messaging application has a command button to invite other users to start an instant messaging session (invite command buttons 145 and 190).

Finally, each instant messaging application has a command button to close the instant messaging application (close command buttons 150 and 195).

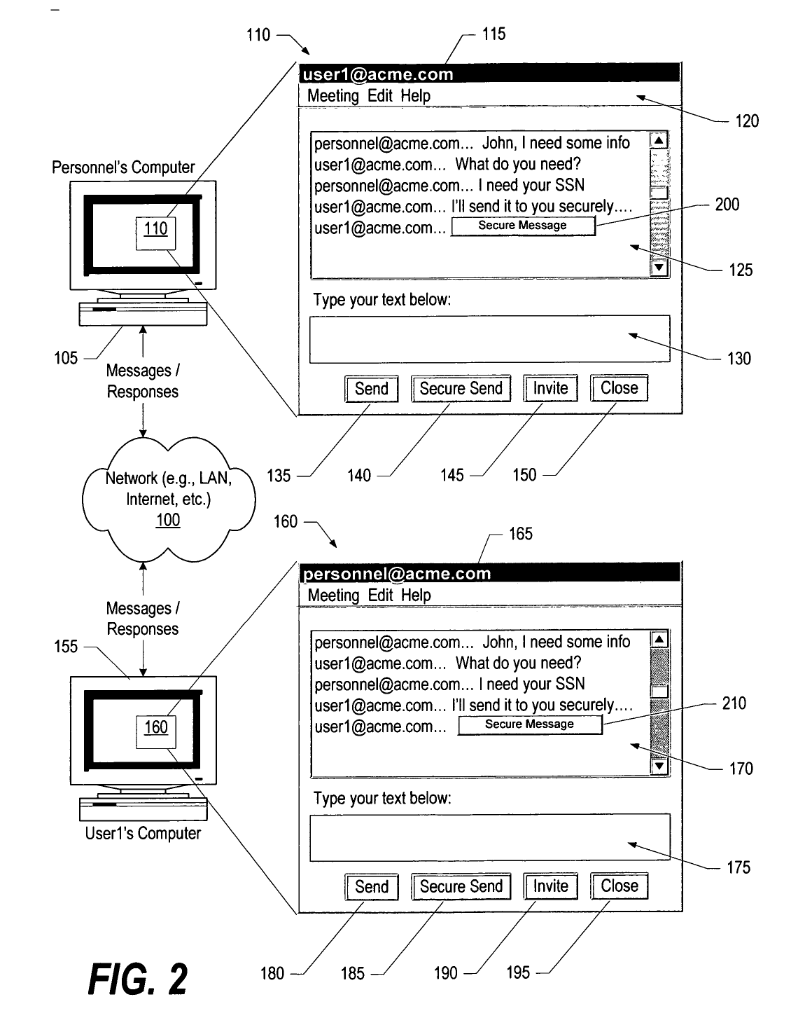

In the example shown in FIG. 1, as the text in the display windows indicates, the personnel user has asked User1 for his or her social security number. The employee (User1) has entered his or her social security number in input text box 175 and has selected Secure Send command button 185 to send the information to personnel's computer 105 securely. FIG. 2 will show the resulting views after User1's social security number has been sent securely.

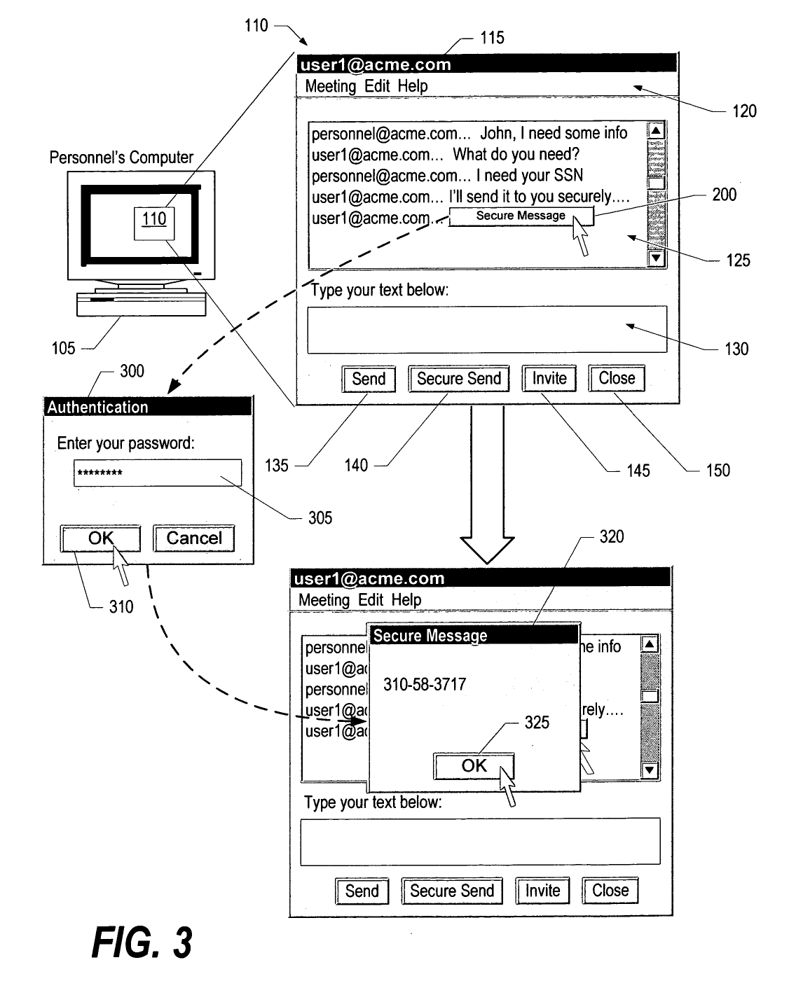

FIG. 2 is a diagram showing the result of one of the computers sending a secure message to the other computer. FIG. 1 outlined the steps that User1 employed to securely send his or her social security number to personnel's computer 105. In FIG. 2, command buttons 200 and 210 appear in display windows 125 and 170, respectively. The users can now select the “secure message” command button to see the secure message. FIG. 3 will show the resulting views of the user of the personnel's computer selecting the secure message command button.

FIG. 3 is a diagram showing the secure message being received and authenticated by one of the computers. The user of personnel's computer 105 selects secure message command button 200 whereupon identity authentication window 300 appears. The user of personnel's compute 105 enters his or her identity authentication, such as a password, in password text box 305 and then selects “OK” command button 310. In order to protect the identity authentication from being viewed by others, password text box 305 masks the users identity authentication so that the actual authentication data does not appear. If the identity of the user is verified, the secure message is displayed. In one embodiment, the secure message (the requested social security number) is displayed in pop-up window 320. When the user is finished viewing the secure message, he or she presses “OK” command button 325 which closes the pop-up window. In this manner, the secure message is not left on the user's screen if the user leaves his or her computer. If the user wants to re-view the secure message, he or she simply selects secure message command button 200 to restart the process.

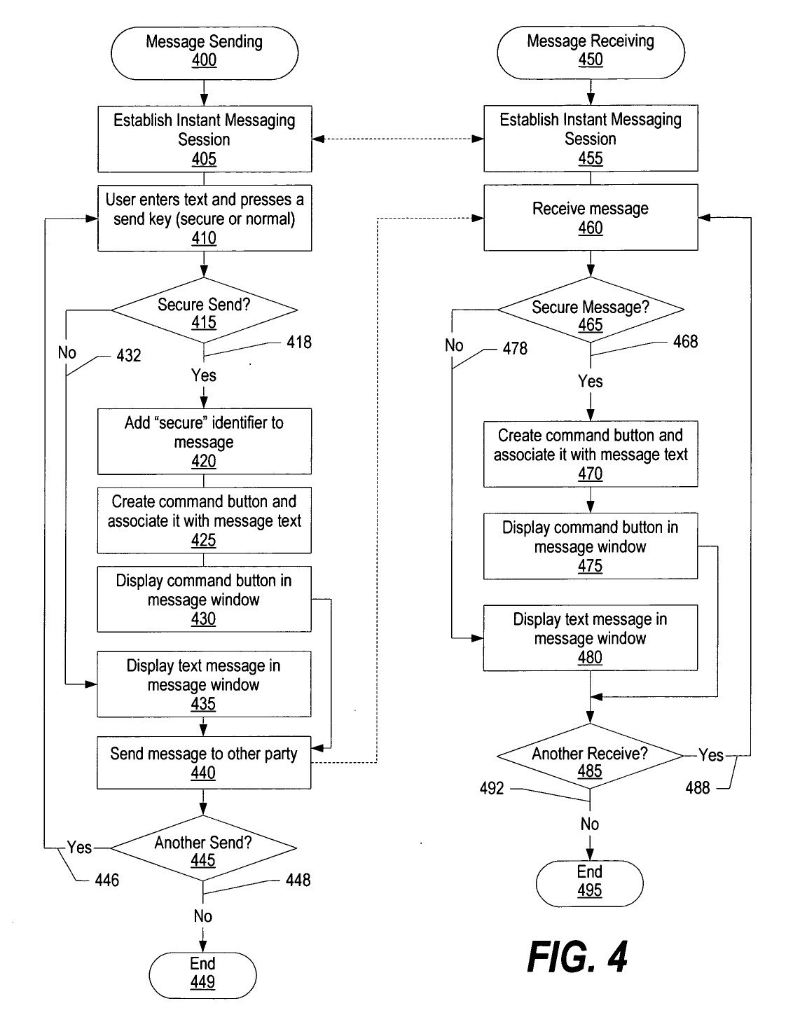

FIG. 4 is a flowchart showing steps taken in sending and receiving secure instant messages between two computers. Message sending processing commences at 400 whereupon, at step 405, an instant messaging session is established between a first instant messaging application running on a first computer and a second instant messaging application running on a second computer. Message sending is performed by the second computer system running second instant messaging application and commences at 400.

Message receiving is performed by the first computer system running first instant messaging application and commences at 450.

After a session has been established between the receiver's instant messaging application (the first instant messaging application) and the sender's instant messaging application (the second instant messaging application), at step 410 the sender enters text that the sender wishes to send to the receiver. A determination is made as to whether the text is to be sent “securely” or normally (decision 415, i.e., based upon a command button selected by the sender).

If the text is to be sent securely, decision 415 branches to “yes” branch 418 whereupon, at step 420, a “secure” identifier is added to the message. In one embodiment, the message text is encrypted (i.e., using a public key corresponding to the receiver so the receiver can only decrypt after providing the receiver's private key). At step 425, a command button (a GUI control) is created and the text is associated with the command button.

At step 430, the command button is displayed in the sender's message display window. If the sender wishes to see the message he or she selects the command button and, when prompted, provides the sender's identity authentication (e.g., password) to view the secure text. At step 440, the secure message is sent to the receiver. On the other hand, if the message is not secure, decision 415 branches to “no” branch 432 bypassing steps 420-430 and the text is displayed in the sender's message display window (step 435) and the non-secure message is sent to the receiver (step 440).

A determination is made as to whether the sender wishes to send another message (decision 445). If another message is sent, decision 445 branches to “yes” branch 446 which loops back to receive and process the next message. This looping continues until no more messages are to be sent (i.e., the sender closes the instant messaging application), at which point decision 445 branches to “no” branch 448 and processing ends at 449.

Returning to the message receiving processing, at step 460, the message (secure or non-secure) is received. A determination is made as to whether the message is a secure message (decision 465). If the message is a secure message, decision 465 branches to “yes” branch 468 whereupon, at step 470 a command button (a GUI control) is created and associated with the message text. In one embodiment, the associated message text is encrypted. At step 475, the command button is displayed in the receiver's display window of the instant messaging application (see FIGS. 2 and 3 for examples of a command button that is created and appears in the display window). Returning to decision 465, if the message is not a secure message, then decision 465 branches to “no” branch 478 bypassing steps 470 and 475 and the text is displayed in the display window at step 480 (again, see FIGS. 1-3 for examples of non-secure text messages displayed in the display windows).

A determination is made as to whether more messages are received (decision 485). If another message (secure or non-secure) is received, decision 485 branches to “yes” branch 488 which loops back to receive and process the next message. This looping continues until there are no more messages to receive (i.e., the receiver closes the instant messaging application), at which point decision 485 branches to “no” branch 492 and receiver processing ends at 495. It will be apparent to those of skill in the art with benefit of the instant detailed description that both users in an instant messaging session perform both the sending and receiving processing (sending processing used to send the other party a message and receiving processing used to receive a message sent from the other party).

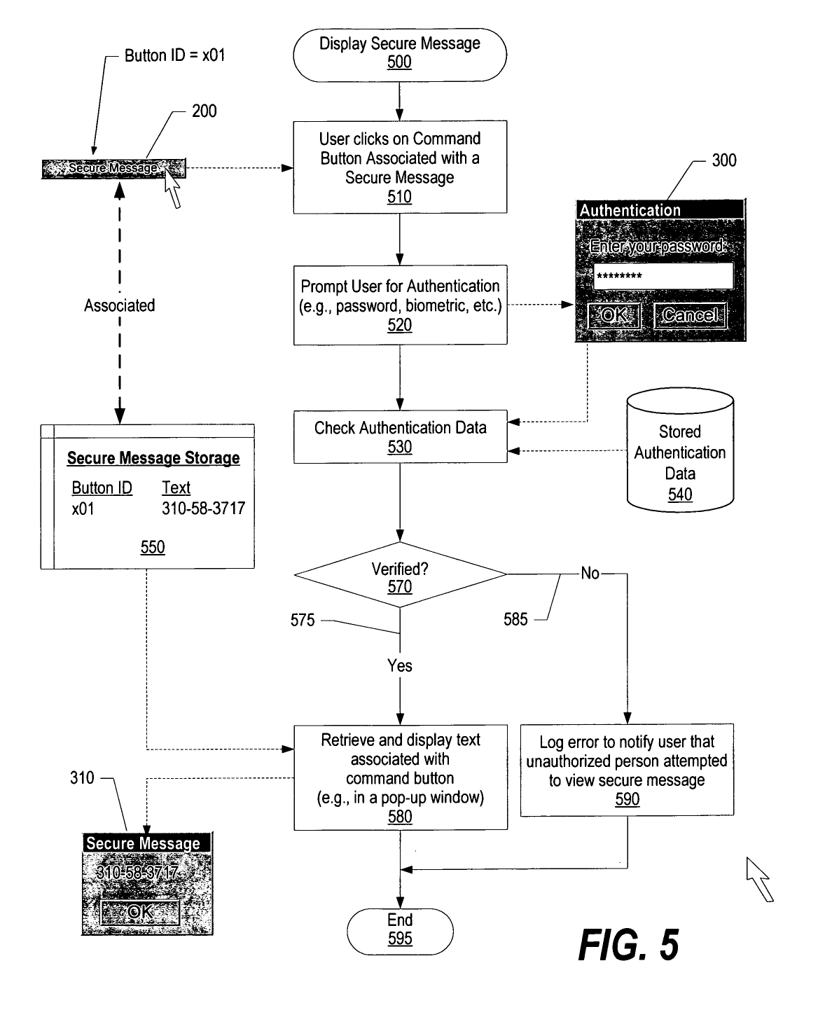

FIG. 5 is a flowchart showing steps taken in displaying a secure instant message. Processing commences at 500 when, at step 510, the user selects a command button (command button 200) that is associated with a secure message. At step 520, the user is prompted for identity authentication data which is entered in authentication dialog 300. At step 530, the identity authentication data provided by the user is compared with stored authentication data 540 (such as a password entered by the user being compared with a password stored on the user's computer system).

A determination is made as to whether the identity authentication data was successfully verified (decision 570). If the identity authentication data was successfully verified, decision 570 branches to “yes” branch 575 whereupon, at step 580, the secure message associated with the command button is retrieved from secure message storage 550 and displayed to the user. In one embodiment, the secure message text is stored in an encrypted format and is decrypted in response to the verification of the identity authentication data. In one embodiment, pop-up window 310 is used to display the secure text. When the pop-up window is closed, in order to view the secure text, the user repeats the process of selecting the command button and entering the identity authentication data. In this manner, the secure message is not visible or accessible by others once the pop-up is closed so that, if the user leaves his or her desk, a passerby cannot view the secure message. Processing thereafter ends at 595.

Returning to decision 570, if the user's identity authentication data is not verified, decision 570 branches to “no” branch 585 whereupon, at step 590, the error is logged so that the user can be informed that an unauthorized user attempted to view one of the user's secure messages that appeared in the user's instant messaging application. Processing thereafter ends at 595.

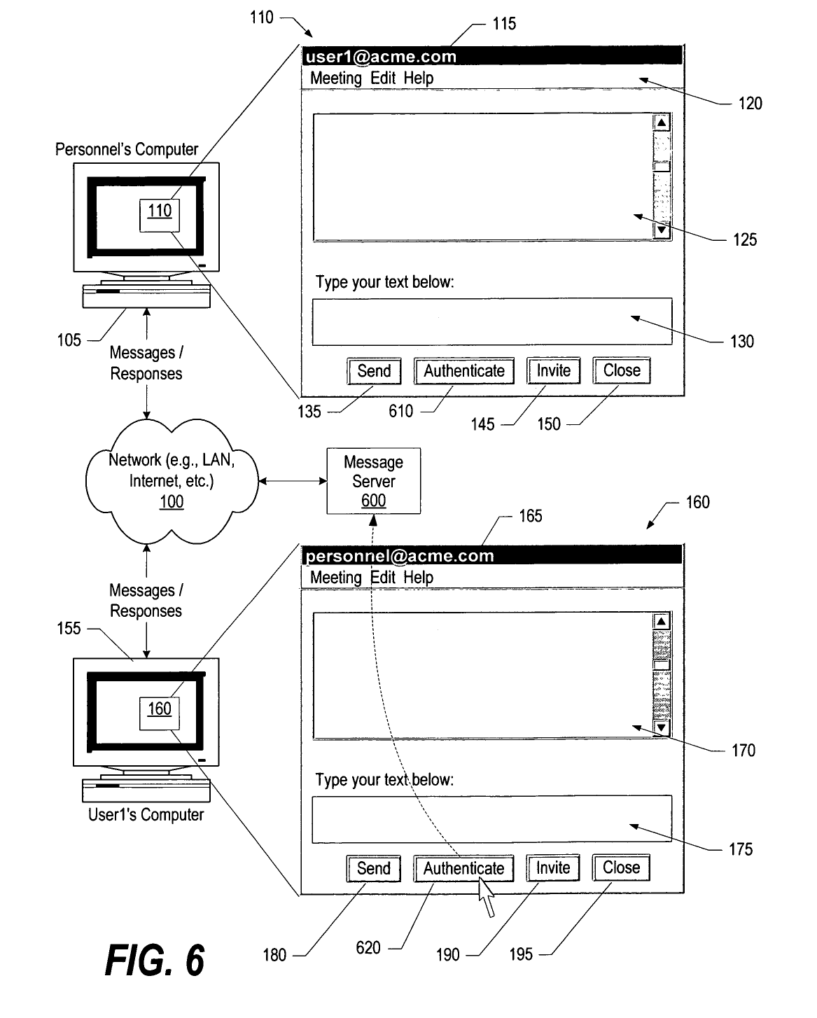

FIG. 6 is a diagram showing a message server being used to facilitate the transmission and reception of secure messages. FIG. 6 is similar to FIG. 1. However, in FIG. 6 the “Secure Send” command button in the user's instant messaging applications has been replaced with “Authenticate” command button (610 and 620). In addition, message server compute 600 is used to facilitate the instant messaging session between personnel's computer 105 and user1's computer 155. It will be apparent to those of skill in the art having benefit of the present detailed description that both a “Secure Send” command button and an “Authenticate” command button could be used. The “Authenticate” command button, as discussed in further detail below, is used to request that the other user authenticate himself or herself. In one embodiment, the message server is used to perform the authentication, making it more difficult for a surreptitious user, such as a hacker, to spoof the authentication data. In FIG. 6, User1 is selecting Authenticate command button 620 in order to request that the user of personnel's computer system authenticate himself or herself. In one embodiment, this request is transmitted to message server 600. In another embodiment, this request is transmitted directly to the other party (in this case, personnel's computer 105).

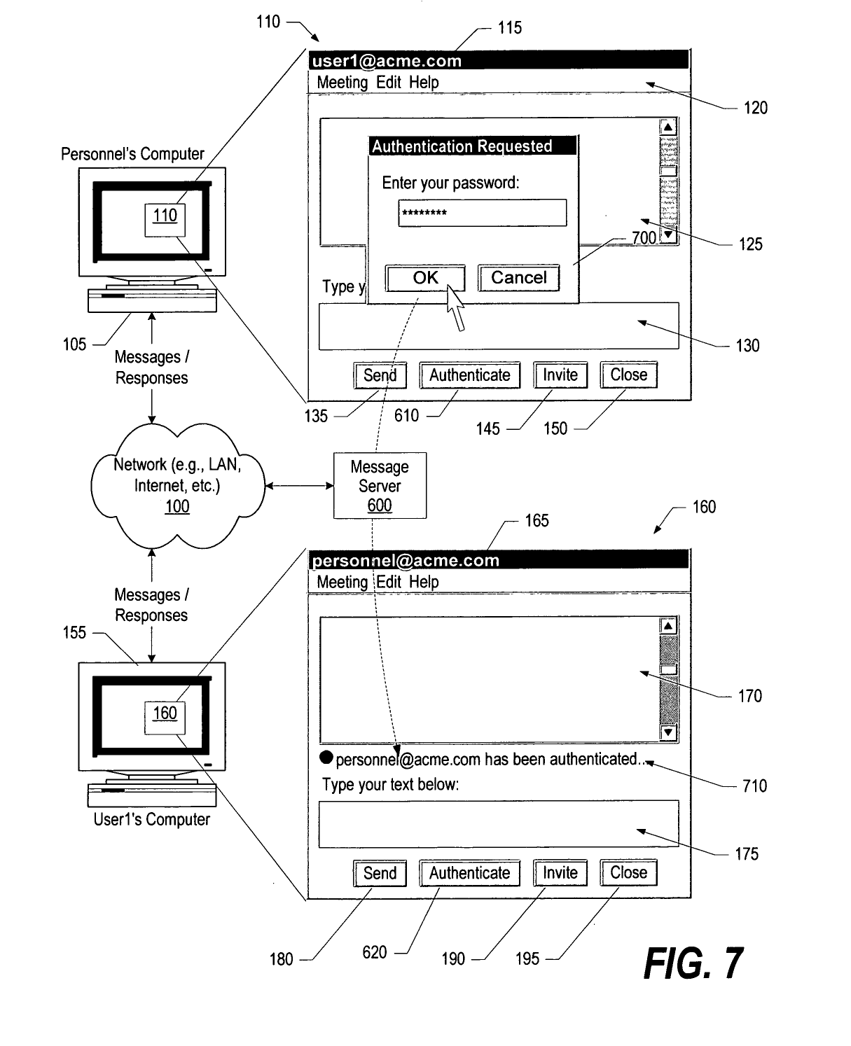

FIG. 7 is a diagram showing the message server authenticating a user before transmitting a secure message. In response to User1's authentication request (see FIG. 6), authentication dialog 700 is displayed on the display of the computer of which authentication is being requested (in this case, personnel's computer 105). The user enters his or her identity authentication data (e.g., a password) into the textbox included in authentication dialog 700. The user then selects the “OK” command button to transmit the identity authentication data to message server 600. Message server 600 verifies the identity authentication data and, if verified, displays verification message 710 on the display of the user that requested authentication of the other user (in this case, on User1's display 155). In one embodiment, the authentication message is protected (i.e., encrypted) so that a malicious user cannot spoof the authentication message received by the user (e.g., received and displayed on user1's display).

In one embodiment, an expiration mechanism is used to prevent repeated authentication failures. In this embodiment, the message server keeps track of authentication failures from the user being authenticated (e.g., the personnel user) and limits the failure messages sent to the other user (e.g., user1). In another embodiment, the communication pipe between the users of the instant messaging sessions is considered less reliable (i.e., less secure) as a function of time that has elapsed since the last authentication was performed. In this embodiment, authentication credentials can be re-negotiated after a preset condition is triggered (e.g., after a timeout period, an away/idle setting, etc.).

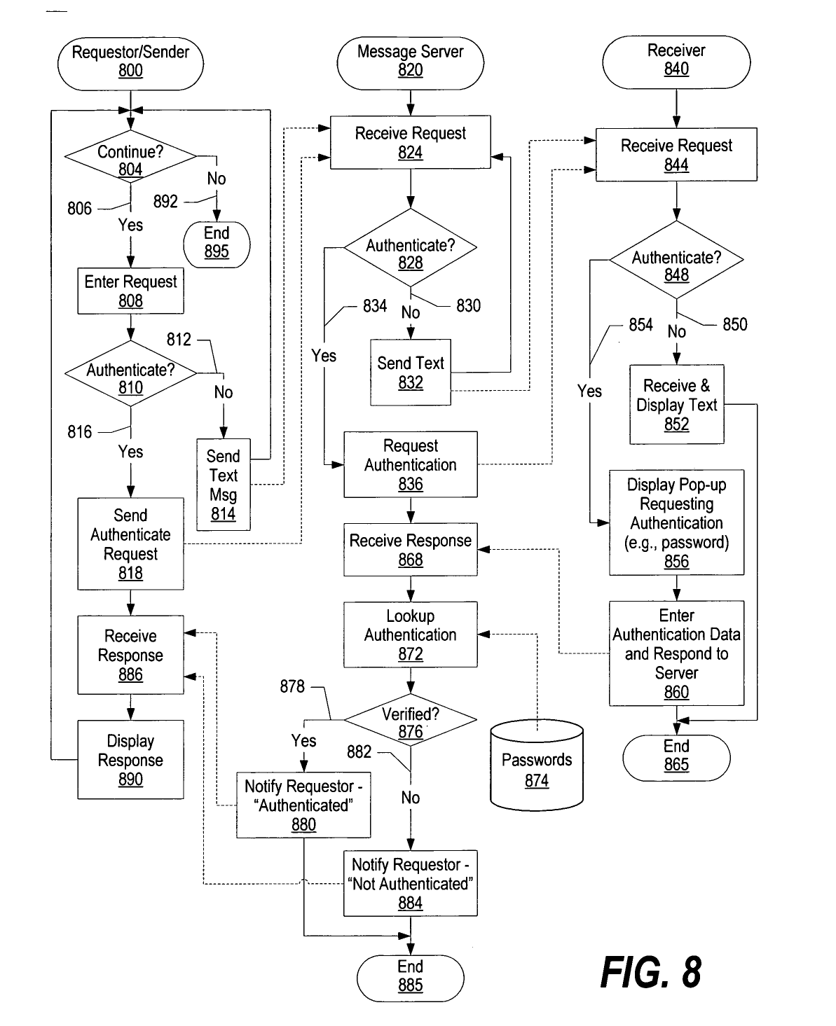

FIG. 8 is a flowchart showing steps taken in sending and receiving secure instant messages between two computers using a message server to facilitate authentication. Processing by the requestor (the computer requesting identity authentication in order to send sensitive, or secure, data) commences at 800. A determination is made as to whether the requestor wishes to continue (decision 804). This decision will branches to “yes” branch 806 until the requester closes the instant messaging application, at which point decision 804 branches to “no” branch 892.

At step 808, the requestor enters a request (i.e., by selecting one of the command buttons shown in FIGS. 6 and 7). A determination is made as to whether the request is to authenticate the other party in an instant messaging session (decision 810). If the request is not for authentication of the other party, decision 810 branches to “no” branch 812 whereupon, at step 814 an instant message (text message) is sent to the other party through the message server. On the other hand, if the request is for authentication of the other party, decision 810 branches to “yes” branch 816 whereupon, at step 818, the authentication request is sent to the message server.

Message server processing commences at 820 whereupon, at step 824, the message server receives a request. A determination is made as to whether the request is for authentication of one of the users of an instant messaging session. If the request is not for authentication, decision 828 branches to “no” branch 830 whereupon, at step 832, the text message is forwarded to the other party. On the other hand, if the request is for authentication, decision 828 branches to “yes” branch 834 whereupon, at step 836, authentication is requested. In one embodiment, the request of authentication results in an authentication dialog being displayed on the receivers display.

Receiver processing commences at 840 whereupon, at step 844 the receiver receives a request. A determination is made as to whether the request is for the user to authenticate himself or herself by providing identity authentication data, such as a password (decision 848). If the request is not for authentication, decision 848 branches to “no” branch 850 whereupon, at step 852, the text is received and displayed in the user's instant messaging application. On the other hand, if the request is for authentication, decision 848 branches to “yes” branch 854 whereupon, at step 856 an authentication dialog is displayed (such as pop-up window 700 shown in FIG. 7). At step 860, the user enters his or her identity authentication data, such as a password, into a text box provided on the authentication dialog and this authentication data is transmitted to the message server. Receiver processing thereafter ends at 865.

Returning to message server processing, at step 868, the message server receives the identity authentication data, such as a password, from one of the parties involved in the instant messaging session. At step 872, the user's authentication data is retrieved from data store 874 and compared with the provided identity authentication data. A determination is made as to whether the identity authentication data is verified (i.e., matches the stored authentication data) at decision 876. If the data is verified, decision 876 branches to “yes” branch 878 whereupon, at step 880, a message is transmitted to the other party of the instant messaging session indicating that the party's identity was authenticated. On the other hand, if the identity was not verified, decision 876 branches to “no” branch 882 whereupon, at step 884, a messages is transmitted to the other party indicating that the party's identity was not authenticated. Message server processing thereafter ends at 885.

Finally, returning to requestor processing, the response from the message server is received at step 886. The response indicates whether or not the other party of the instant messaging session successfully verified his or her identity. At step 890, an appropriate message is displayed in the requestor's instant messaging application conveying the results of the authentication request.

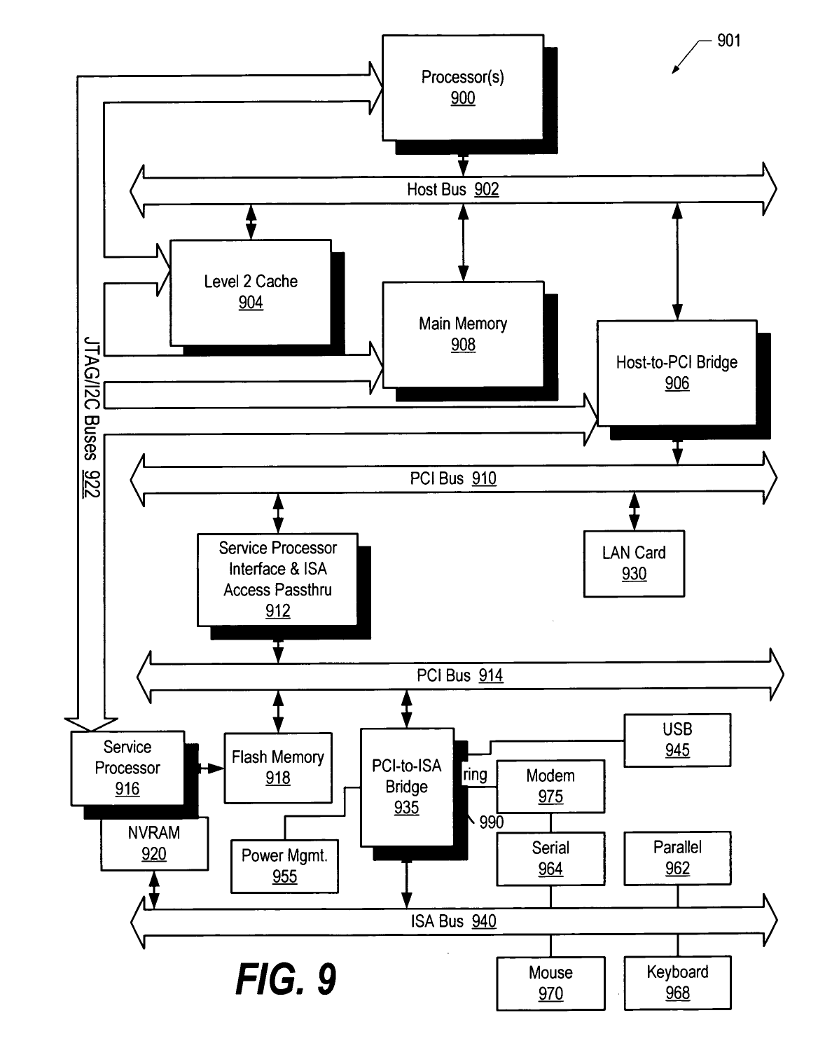

FIG. 9 illustrates information handling system 901 which is a simplified example of a computer system capable of performing the computing operations described herein. Computer system 901 includes processor 900 which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provides an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCI-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C busses 922 for communication with processor(s) 900 during initialization steps. JTAG/I2C busses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the invention described herein, this computer system is simply one example of a computer system. Those skilled in the art will appreciate that many other computer system designs are capable of performing the invention described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects.

Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
establishing an instant messaging session between a first instant messaging application running on a first computer and second instant messaging application running on a second computer, wherein the first and second computers are connected to each other using a computer network;
after the instant messaging session has been established, requesting identity authentication from a first user of the first instant messaging application;
receiving the identity authentication data from the first user;
verifying an identity of the first user based upon the received identity authentication data; and
displaying, in the first instant messaging application, a secure message to the first user in response to successfully verifying the identity of the first user.

2. The method of claim 1 further comprising:
sending the secure message from the second instant messaging application to the first instant messaging application;
receiving, at the first instant messaging application, the secure message; displaying a control visible in the first instant messaging application in response to receiving the secure message; and
selecting the displayed control by the first user, wherein the requesting of the identity authentication from the first user is performed in response to the selection.

3. The method of claim 2 further comprising:
displaying a dialog at the first computer that includes the secure message each time the displayed control is selected and the identity of the first user is verified.

4. The method of claim 1, wherein the secure message sent from the second computer system is encrypted, the method further comprising:
storing the encrypted secure message on the first computer system prior to verifying the identity of the first user; and
decrypting the stored encrypted secure message in response to verifying the identity of the first user.

5. The method of claim 1 wherein the receiving of the identity authentication data from the first user is performed by a message server, the method further comprising:
receiving at the message server the identity authentication data provided by the first user;
comparing the received identity authentication data with authentication data maintained by the message server;
sending an authenticated message from the message server to the second computer in response to a successful comparison; and
notifying the second user by displaying the authenticated message in the second instant messaging application.

6. The method of claim 5 further comprising:
sending a request from the second computer to the message server that the identity of the first user be verified;
sending the identity authentication request from the message server to the first computer; and
displaying the identity authentication request in the first instant messaging application.

7. The method of claim 5 further comprising:
receive the secure message at the second instant messaging application in response to the notification; and
sending the secure message from the second computer to the first computer after the secure message is entered by the second user.

8. An information handling system comprising:
one or more processors;
one or more network adapters connecting the information handling system to a computer network;
a memory accessible by the processors;
a display device accessible by the processors; one or more input devices; and
a process operated by the processors that authenticates instant messaging users, the process being effective to:
establish an instant messaging session between a first instant messaging application running the processors and second instant messaging application running on a second information handling system, wherein the information handling system and the second information handling system are connected to each other using the computer network;
after the instant messaging session has been established, request identity authentication from a first user of the first instant messaging application;
receive, using one of the input devices, the identity authentication data from the first user;
verify an identity of the first user based upon the received identity authentication data; and
display, on the display device, a secure message to the first user in response to successfully verifying the identity of the first user.

9. The information handling system of claim 8 wherein the process is further effective to:
send the secure message from the second instant messaging application to the first instant messaging application using the computer network;
receive, at the first instant messaging application, the secure message;
display, on the display device, a graphical control visible in the first instant messaging application in response to receiving the secure message; and
select, using one of the input devices, the displayed control, wherein the request of the identity authentication from the first user is performed in response to the selection.

10. The information handling system of claim 9, wherein the process is further effective to:
display a dialog on the display device that includes the secure message each time the displayed control is selected and the identity of the first user is verified.

11. The information handling system of claim 8, wherein the secure message sent from the second information handling system is encrypted, and wherein the process is further effective to:
store the encrypted secure message in the memory prior to verifying the identity of the first user; and decrypt the stored encrypted secure message in response to verifying the identity of the first user.

12. The information handling system of claim 8 wherein the reception of the identity authentication data from the first user is performed by a message server, the information handling system further comprising:
receive at the message server the identity authentication data provided by the first user;
compare the received identity authentication data with authentication data maintained by the message server;
send an authenticated message from the message server to the second computer in response to a successful comparison; and
notify the second user by displaying the authenticated message in the second instant messaging application.

13. The information handling system of claim 12 further comprising:
send a request from the second computer to the message server that the identity of the first user be verified;
send the identity authentication request from the message server to the first computer; and
display the identity authentication request in the first instant messaging application.

14. A program product comprising:
a computer operable medium having computer readable code, the computer readable code being effective to:
establish an instant messaging session between a first instant messaging application running on a first computer and second instant messaging application running on a second computer, wherein the first and second computers are connected to each other using a computer network;
after the instant messaging session has been established, request identity authentication from a first user of the first instant messaging application;
receive the identity authentication data from the first user;
verify an identity of the first user based upon the received identity authentication data; and
display, in the first instant messaging application, a secure message to the first user in response to successfully verifying the identity of the first user.

15. The program product of claim 14 further comprising computer readable code being effective to:
send the secure message from the second instant messaging application to the first instant messaging application;
receive, at the first instant messaging application, the secure message;
display a control visible in the first instant messaging application in response to receiving the secure message; and
select the displayed control by the first user, wherein the requesting of the identity authentication from the first user is performed in response to the selection.

16. The program product of claim 15 further comprising computer readable code being effective to:
display a dialog window at the first computer that includes the secure message each time the displayed control is selected and the identity of the first user is verified.

17. The program product of claim 14, wherein the secure message sent from the second computer system is encrypted, the program product further comprising computer readable code being effective to:
store the encrypted secure message on the first computer system prior to verifying the identity of the first user; and
decrypt the stored encrypted secure message in response to verifying the identity of the first user.

18. The program product of claim 14 wherein the receiving of the identity authentication data from the first user is performed by a message server, the program product further comprising computer readable code being effective to:
receive at the message server the identity authentication data provided by the first user;
compare the received identity authentication data with authentication data maintained by the message server;
send an authenticated message from the message server to the second computer in response to a successful comparison; and
notify the second user by displaying the authenticated message in the second instant messaging application.

19. The program product of claim 18 further comprising computer readable code being effective to:
send a request from the second computer to the message server that the identity of the first user be verified;
send the identity authentication request from the message server to the first computer; and
display the identity authentication request in the first instant messaging application.

20. The program product of claim 18 further comprising:
receive the secure message at the second instant messaging application in response to the notification;
and send the secure message from the second computer to the first computer after the secure message is entered by the second user.
